(19) United States
(12) Patent Application Publication
(10) Pub. No.: US 2019/0174734 A1
(43) Pub. Date: Jun. 13, 2019

(54) ROD HOLDING DEVICE AND METHODS OF USE

(71) Applicant: ROD DAWG HOLDINGS LLC, Iron Mountain, MI (US)

(72) Inventors: BRANDON DAVID ROUSE, IRON MOUNTAIN, MI (US); JAMES FRANCIS BRACKETT, KINGSFORD, MI (US)

(73) Assignee: ROD DAWG HOLDINGS LLC, Iron Mountain, MI (US)

(21) Appl. No.: 16/211,191

(22) Filed: Dec. 5, 2018

Related U.S. Application Data
(60) Provisional application No. 62/596,798, filed on Dec. 9, 2017.

(51) Int. Cl. A01K 97/10; B63B 17/00

(52) U.S. Cl. CPC A01K 97/10; B63B 2017/0054; B63B 17/00

(57) ABSTRACT

A rod holding device comprises an elongate low strut, an elongate pivot strut, a first range plate, and a second range plate. The first range plate is spaced from the second range plate and both plates are fixed to a superior end of the low strut which is positioned between the range plates. A pivot joint provides pivoting motion between the pivot strut and low strut for various storage and operational configurations. A clamp assembly engages the first range plate, second range plate and pivot strut for angular locking between the pivot strut and the low strut. A holder assembly comprising an upper rod holder and a lower rod holder is fixed to the pivot strut for holding rods therein. The rod holding device is releasable from an anchor fixed to a base panel.

This non-provisional patent application claims priority to Provisional Patent Application No. 62/596,798 filed Dec. 9, 2017, the entire disclosure of which is hereby incorporated by reference and relied upon.

### BACKGROUND OF THE INVENTION

### Field of the Invention

The invention relates generally to holding devices, and more particularly to adjustable rod holding devices.

Transporting rods such as fishing rods can be challenging due to the length of the rods and the difficulty of holding rods in a bundle. This is due not only to the multiple appendages on the rods such as reels, handles, eyelets, fishing line, hooks, and lures, but also due to unbalanced weight distribution from one end of the rod to another. The length of rods can make storage in a boat or elsewhere very difficult and can be an obstruction and safety hazard for people walking inside a boat. Rods that are not tucked away can easily catch on overhead structures such as electrical lines, branches, and garage door obstructions.

What is needed are rod holding devices that can arrange and hold rods in a compact bundle yet capable to access any one individual rod. What is needed is a rod holding device that is quickly releasable from an anchor point somewhere on a boat so the rods can be stored as a convenient bundle and easily moved. The rod holding device needs to be adjustable to various angles whereby it is generally upright when used for fishing, or folded down to prevent catching the rods on any nearby objects either overhead, on sides, or within a given boat.

### SUMMARY OF THE INVENTION

The article of invention is a rod holding device useful for the transport and storage of rods. In preferred embodiments, the article of invention is in the form of a fishing rod holding device.

In one form, a fishing rod holding device comprises a low strut releasably fixed to an anchor at an inferior end.

In one form, the low strut is in the form of an elongate cylindrical tube.

In one form, the low strut is generally vertical.

In one form, the low strut comprises a transition interface fixed to an inferior end for releasable coupling with an anchor.

In one form, an anchor supporting a low strut is secured to a base panel of a boat.

In one form, a boat seat comprising a transition interface is substituted with a rod holding device for fixation in anchor fixed to a base panel of a boat.

In one form, a pivot strut is pivotably coupled to a superior end of the low strut.

In one form, a pivot strut is in the form of an elongate square or rectangular tube.

In one form, a first range plate is fixed to at least one of a low strut and a pivot strut.

In one form, a first range plate is spaced from a second range plate and are fixed to at least one of a low strut and a pivot strut.

In one form, one or more of a first range plate and a second range plate are fixed by welds to at least one of a low strut and a pivot strut.

In one form, a range plate is generally flat with a generally circular profile defined by a perimeter face.

In one form, a range plate comprises a generally arcing clamp channel defined by a channel face inset from a perimeter face and wherein the channel face extends between an outer range face and an inner range face.

In one form, the clamp channel extends through an arc greater than 90 degrees.

In one form, the clamp channel extends through an arc of at least 120 degrees.

In one form, the clamp channel extends through an arc of about 160 degrees.

In one form, the clamp channel extends through an arc of more than 180 degrees.

In one form, an arcing clamp channel extending between an outer range face and an inner range face terminates in a first stop surface and a second stop surface at opposed ends of the clamp channel.

In one form, an alignment notch extends inward from the perimeter face of a range plate between a first stop surface and second stop surface for seating of a portion of one or more of a low strut and a pivot strut.

In one form, an alignment notch of a range plate is defined by a notch face.

In one form, an alignment notch of a range plate is generally square or rectangular in profile.

In one form, a range plate comprises a generally centralized pivot aperture defined by a pivot face which extends between an outer range face and an inner range face for housing a pivot bolt.

In one form, a weight aperture is positioned medial to a clamp channel and extends between an outer range face and an inner range face for weight reduction.

In one form, one or more of a first range plate and a second range plate are fixed to a strut surface at a superior end of a low strut.

In one form, one or more of a first range plate and a second range plate are fixed at an alignment notch to a strut surface of a low strut using a weld.

In one form, a pivot strut comprises a pivot hole at an inferior end for housing a pivot assembly to serve as a pivot axis.

In one form, a pivot hole on a pivot strut is aligned with a pivot aperture on a range plate for controlled pivoting motion therebetween using a pivot assembly.

In one form, a pivot strut comprises a clamp hole spaced from an inferior end for housing a clamp assembly for holding a desired angulation between a pivot strut and low strut.

In one form, a clamp hole on a pivot strut is aligned with a clamp channel on a range plate for pivotal clamping therebetween using a clamp assembly.

In one form, a pivot assembly comprises a pivot spacer, a pivot bolt, a pivot nut, a first pivot washer, and a second pivot washer.

In one form, a clamp assembly comprises a lock spacer, a clamp shaft, a first inner clamp washer, a second inner clamp washer, a first outer clamp washer, a second outer clamp washer, a first clamp knob and a second clamp knob.

In one form, a first clamp knob is fixed to a clamp shaft.

In one form, a second clamp knob threadably engages a clamp shaft.

In one form, a first clamp knob and a second clamp knob threadably engage a clamp shaft.

In one form, a clamp shaft comprises an enlarged clamp head.

In one form, the clamp head comprises drive faces.

In one form, a holder assembly comprises an upper rod holder and a lower rod holder.

In one form, a holder assembly comprises an upper rod holder, a lower rod holder, and one or more of a first holder stabilizer and a second holder stabilizer extending between the upper rod holder and lower rod holder.

In one form, a portion of a holder assembly is fixed to a distal end portion of a pivot strut.

In one form, a portion of a holder assembly is fixed to a distal end portion of a pivot strut using one or more of welds and fasteners.

In one form, an upper rod holder comprises an upper rod collar.

In one form, an upper rod collar is generally oval having a generally oval first central aperture.

In one form, a lower rod collar is generally oval having a generally oval second central aperture.

In one form, one or more of the first central aperture and second central aperture are sized to house a pivot strut therein.

In one form, an upper rod collar and a lower rod collar are fixed on a pivot strut in planes generally perpendicular to a pivot strut.

In one form, spaced radially from said upper rod collar and said lower rod collar are a plurality of cages.

In one form, said plurality of cages extending from the upper rod collar generally reside in a common plane with the upper rod collar.

In one form, said plurality of cages extending from the lower rod collar generally reside in a common plane with the lower rod collar.

In one form, an upper cage defines an upper rod tunnel for containing a portion of a rod therein.

In one form, a lower cage defines a lower rod tunnel for containing a portion of a rod therein.

In one form, individual upper cages are generally aligned with individual lower cages such that a rod can be captured therein along aligned axes.

In one form, a holder assembly is fixed to a distal end of a pivot strut.

In one form, a holder assembly is fixed to a distal end of a pivot strut using welds.

In one form, a pivot strut is moveable through a range of motion thereby positioning rods held within a holder assembly in a plurality of angular positions.

In one form, a clamp shaft portion of a clamp assembly travels within a clamp channel of a range plate wherein said assembly may be locked at any position within the clamp channel.

In one form, a clamp shaft portion of a clamp assembly travels within a clamp channel of a range plate wherein said assembly may be locked predefined positions within the clamp channel.

In one form, a clamp shaft spans across a pair of spaced range plates.

In one form, a pivot range of a pivot strut is limited by interference between a portion of a clamp assembly and one or more of a first stop surface and a second stop surface within a range plate clamp channel.

In one form, a clamp assembly is locked by advancing one or more of a first clamp knob and a second clamp knob causing a frictional locking between the clamp assembly and corresponding range plate in a locked configuration.

In one form, a clamp assembly is unlocked by reversing advancement of one or more of a first clamp knob and a second clamp knob causing a reduction of frictional locking between the clamp assembly and corresponding range plate in an unlocked configuration.

In one form, a user places a fishing rod holding device in an unlocked configuration and adjusts a corresponding pivot strut to a new predetermined position then changes the corresponding clamp assembly to a locked configuration.

In one form, a clamp assembly is in the form of a cammed quick release rod and skewer.

In one form, a cammed quick release rod and skewer comprises a cam pad on which a cam lobe from a cam lever articulates.

In one form, a cam shaft is positioned generally perpendicular to a clamp shaft of a cammed quick release rod and skewer.

In one form, a clamp assembly is locked by pivoting a cam lever causing a frictional locking between the clamp assembly and corresponding range plate in a locked configuration.

In one form, a clamp assembly is unlocked by reversing pivoting of a cam lever causing a frictional unlocking between the clamp assembly and corresponding range plate in an unlocked configuration.

In one form, one or more of a first range plate and a second range plate comprises a plurality of recess surfaces inset from an outer range face.

In one form, the recess surfaces are radially centered and spaced about a clamp channel.

In one form, a lock face extends between the recess surfaces and the outer range face.

In one form, lock pockets are formed in an outer range face of a range plate and are defined by a recess surface and a lock face.

In one form, a lock pocket is sized and shaped to seat an outer clamp washer.

In one form, and in a locked configuration, an outer clamp washer abuts a lock face to prevent pivoting movement of a range plate from a predesignated position.

In one form, and in an unlocked configuration, an outer clamp washer is able to move past a lock face on the range plate to provide for pivoting adjustment of a holder assembly to a predesignated position.

In one form, a fishing rod holding device comprises a transition interface at a proximal end of a low strut.

In one form, a transition interface is in the form of an interface cup. The interface cup comprises an inner cup face having a size and profile for seating a proximal end of a low strut therein.

In one form, an interface cup comprises an outer cup face having a size and profile suited for seating within an anchor.

In one form, a boat seat comprising a transition interface is substituted with a rod holding device for fixation in an anchor fixed to a base panel of a boat.

In one form, an interface cup comprises a high position boss for seating within a complementing high notch of an anchor thus preventing rotation therebetween.

In one form, an interface cup comprises a low position boss extending inferiorly for seating within a complementing low socket of an anchor.

In one form, an interface cup comprises a lever lock for releasably securing an interface cup within an anchor.

In one form, a base comprises a cup holder portion sized and shaped for seating a corresponding transition interface therein.

In one form, an anchor has a broad base having screw holes at its periphery.

In one form, a broad base is secured to a base panel using one or more base screws.

In one form, a base panel is the floor of a boat.

In one form, a base panel is on the rail of a boat.

In one form, a base panel is a horizontal surface elevated from the floor of a boat.

In one form, when a fishing rod holding device is removed from an anchor, the anchor may be used to support a seat.

In one form, a fishing rod holding device holds a plurality of fishing poles.

In one form, a fishing rod holding device is removed from an anchor for storage.

In one form, a fishing rod holding device with one or more fishing rods seated within an upper rod tunnel and lower rod tunnel is removed from an anchor for storage as a combined fishing rod and fishing rod holding device unit.

In one form, a lever lock is depressed to release a transition interface from an anchor.

In one form, a clamp assembly is in the form of a clamp shaft that is biased in one direction.

In one form, a clamp assembly comprises an engagement knob mounted on one end.

In one form, a clamp assembly comprises an engagement spring for biasing a clamp shaft in one direction.

In one form, an engagement knob comprises a radially positioned engagement face sized to engage a lock pocket on range plate.

In one form, an engagement knob comprises at least one grasp face for grasping by a user's hand.

In one form, an engagement knob comprises a stop face for engagement with an outer range face of a range plate.

In one form, distracting an engagement knob against engagement spring force unlocks an engagement face from a lock pocket providing consequent angle adjustment of a pivot strut relative to a low strut.

In one form, a clamp shaft is pivotable through a clamp channel for adjustment of a pivot strut angle.

In one form, a range plate comprises a series of lock faces forming lock pockets along the length of a clamp channel.

In one form, the lock faces are sized and shaped to seat an engagement face of an engagement knob therein.

In one form, a first range plate comprising a series of lock pockets along a clamp channel is paired with a second range plate absent of lock pockets along a clamp channel.

In one form, a low strut terminates in a releasable foot configured for releasable fixation to an anchor plate.

In one form, the releasable foot comprises a foot plate fixed to the low strut.

In one form, one or more welds join a low strut to a foot plate.

In one form, a base strut reinforces the junction between the low strut and foot plate.

In one form, the base strut is in the form of a tube.

In one form, the base strut resides within the low strut.

In one form, the low strut comprises at least one weld notch at an inferior end for joining the low strut with the base strut using a weld.

In one form, a base strut is seated in a ring aperture extending through the foot plate between a foot bottom and foot top.

In one form, a foot plate comprises an opposing first slot and second slot extending between a foot bottom and foot top from a foot end face of the foot plate.

In one form, an upper lock aperture for housing a lock bolt extends from a foot top to a foot bottom of a foot plate.

In one form, a lock bolt is housed in an upper lock aperture.

In one form, an anchor plate is configured for releasable locking with a foot plate.

In one form, an anchor plate comprises opposed anchor end surfaces.

In one form, an anchor plate comprises opposed anchor side surfaces.

In one form, an anchor plate comprises opposed first plate holes extending between an anchor top surface and anchor bottom surface at one end of the anchor plate.

In one form, an anchor plate comprises opposed second plate holes extending between an anchor top surface and anchor bottom surface of the anchor plate.

In one form, the first plate holes and second plate holes are positioned at opposed ends of the anchor plate.

In one form, at least one of the first plate holes and second plate holes are counter sunk or counter bored for seating of the head of a plate fastener therein.

In one form, lock collar is configured for seating within one or more of a first slot and second slot of a foot plate to provide releasable fixation at one end of the foot plate.

In one form, the lock collar comprises a toe wall sized to fit within one for more of a first slot and second slot of a foot plate.

In one form, the lock collar comprises a bottom collar face for seating against an anchor top surface.

In one form, the lock collar comprises a radially enlarged rim spaced from the bottom collar face.

In one form, the radially enlarged rim comprises a rim face for engaging the foot top of a foot plate when the lock collar is seated within a first slot or second slot.

In one form, the lock collar comprises a collar aperture extending through the lock collar along a central axis.

In one form, the lock collar comprises a countersunk or counter bored head recess for seating the head of a plate fastener therein.

In one form, the anchor plate comprises a lower lock aperture extending between an anchor top surface and an anchor bottom surface of an anchor plate.

In one form, the lower lock aperture is threaded to complement the lock bolt.

In one form, the upper lock aperture and lower lock aperture are aligned when the releasable foot is mated with the anchor plate.

In one form, a first foot plate fastener extends through the collar aperture of a lock collar and through a first plate hole of an anchor plate then seated in a panel of a boat.

In one form, a second foot plate fastener extends through a second plate hole of an anchor plate then seated in a base panel of a boat.

In one form, the head of a second foot plate fastener is seated in a counter sunk or counter bored portion of a second plate hole.

In one form, the low strut stands generally vertical in an operational configuration where the rod holding device is anchored to a base panel of a boat or other vehicle.

In one form, the rod holding device is released from an anchor secured to a base panel of a boat or other vehicle in a storage configuration.

In one form, a rod holding device is made substantially from non-corrosive materials such as non-corrosive metals and polymers.

### DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a perspective view of a rod holding device;

FIG. 2 depicts an exploded perspective view of the rod holding device of FIG. 1;

FIG. 3 depicts a side view of a rod holding device illustrating a tilted holder assembly positioned in one direction;

FIG. 4 depicts a side view of the rod holding device of FIG. 3 with tilted holder assembly positioned in an opposed direction;

FIG. 5 depicts a side view of the rod holding device of FIG. 3 with tilted holder assembly at a discrete position within a range;

FIG. 6 depicts a perspective view of the rod holding device of FIG. 3 illustrating an alignment between upper cages and lower cages in which rods are captured;

FIG. 7 depicts a perspective view of a rod holding device utilizing an alternative style of first range plate and second range plate;

FIG. 8 depicts a perspective view of a range plate utilized on the rod holding device of FIG. 1;

FIG. 9 depicts a perspective view of a range plate utilized on the rod holding device of FIG. 7;

FIG. 10 depicts a perspective view of a pivot assembly;

FIG. 11 depicts a perspective view of a clamp assembly;

FIG. 12 depicts a perspective view of an alternative clamp assembly in the form of a cammed quick release rod and skewer in an unlocked configuration;

FIG. 13 depicts a perspective view of an alternative clamp assembly in the form of a cammed quick release rod and skewer in an locked configuration;

FIG. 14 depicts a perspective view of an upper rod holder;

FIG. 15 depicts a perspective view of a lower rod holder;

FIG. 16 depicts a perspective view of a low strut;

FIG. 17 depicts a low perspective view of a transition interface in the form of an interface cup;

FIG. 18 depicts a high perspective view of the interface cup of FIG. 17;

FIG. 19 depicts a high perspective view of a rod holding device having a transition interface in the form of a releasable foot and anchor plate system and a spring loaded clamp assembly;

FIG. 20 depicts a partial perspective view of the releasable foot and anchor plate system of FIG. 19;

FIG. 21 depicts a perspective view of the anchor plate assembly of FIG. 19;

FIG. 22 depicts an exploded perspective view of the anchor plate assembly of FIG. 19;

FIG. 23 depicts a partial perspective view of the spring loaded clamp assembly and releasable foot of the rod holding device of FIG. 19;

FIG. 24 depicts an exploded partial perspective view of the spring loaded clamp assembly and releasable foot of the rod holding device of FIG. 19;

FIG. 25 depicts a partial bottom perspective view of a weld joining the releasable foot and base strut;

FIG. 26 is a perspective view of the spring loaded clamp assembly of FIG. 23;

FIG. 27 is a perspective view of a first range plate used with a spring loaded clamp assembly;

FIG. 28 is a perspective view of a second range plate used with a spring loaded clamp assembly;

FIG. 29 is a partial perspective view of a spring loaded clamp assembly in a locked configuration;

FIG. 30 is a partial perspective view of a spring loaded clamp assembly in an unlocked position.

FIG. 31 is a partial perspective view of a rod holding device with a plurality of fishing rods seated within an upper rod tunnel and lower rod tunnel of a holder assembly wherein the rod holding device is engaged with an anchor fixed to the floor of a boat and whereas the holder assembly is partially folded down in a operational configuration;

FIG. 32 is a partial perspective view of a rod holding device with a plurality of fishing rods seated within an upper rod tunnel and lower rod tunnel of a holder assembly wherein the rod holding device is engaged with an anchor fixed to a bench at the stern of the boat and whereas the holder assembly is folded down;

FIG. 33 is a partial perspective view of a rod holding device with a plurality of fishing rods seated within an upper rod tunnel and lower rod tunnel of a holder assembly wherein the rod holding device is engaged with an anchor fixed to a bench at the stern of the boat and whereas the holder assembly is extended generally upright;

FIG. 34 is a perspective view illustrating one form of anchor common in the prior art for releasably securing a post to a floor;

FIG. 35 is a perspective view of a releasable foot and anchor plate system of FIG. 19 whereas the anchor plate is mounted to the rail of a fishing boat in an operational configuration;

FIG. 36 is a perspective view of a rod holding device with fishing rod held therein, removed from its anchor for storage at a separate location in a storage configuration.

### DETAILED DESCRIPTION OF SELECTED EMBODIMENTS OF THE INVENTION

Select embodiments of the invention will now be described with reference to the Figures. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein. Like numerals indicate like or corresponding elements throughout the several views and wherein various embodiments are separated by letters (i.e. 100, 100B, 100C).

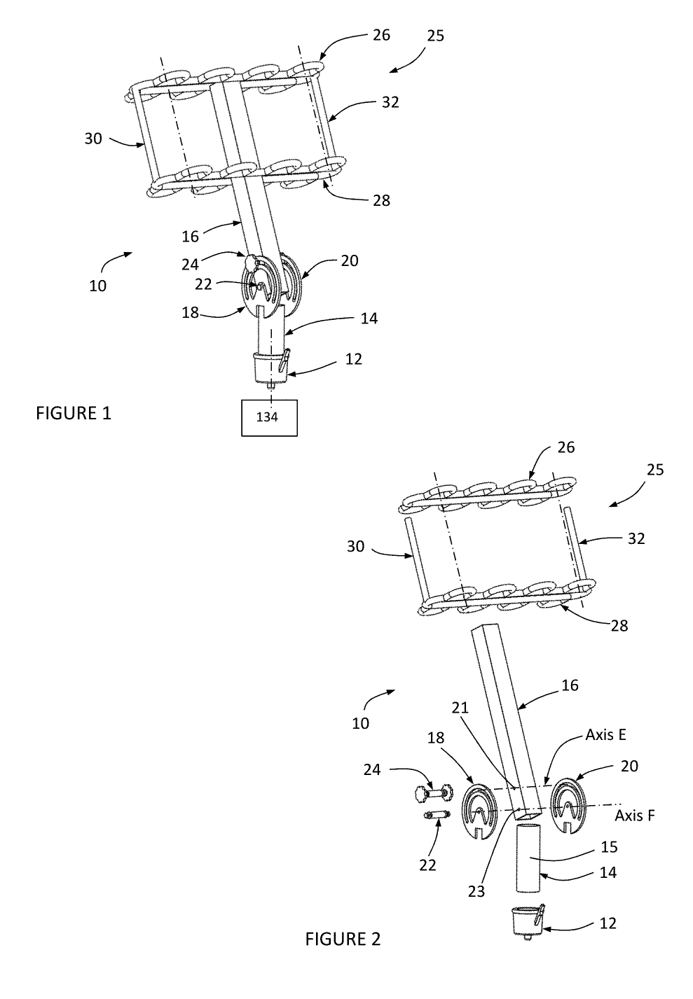

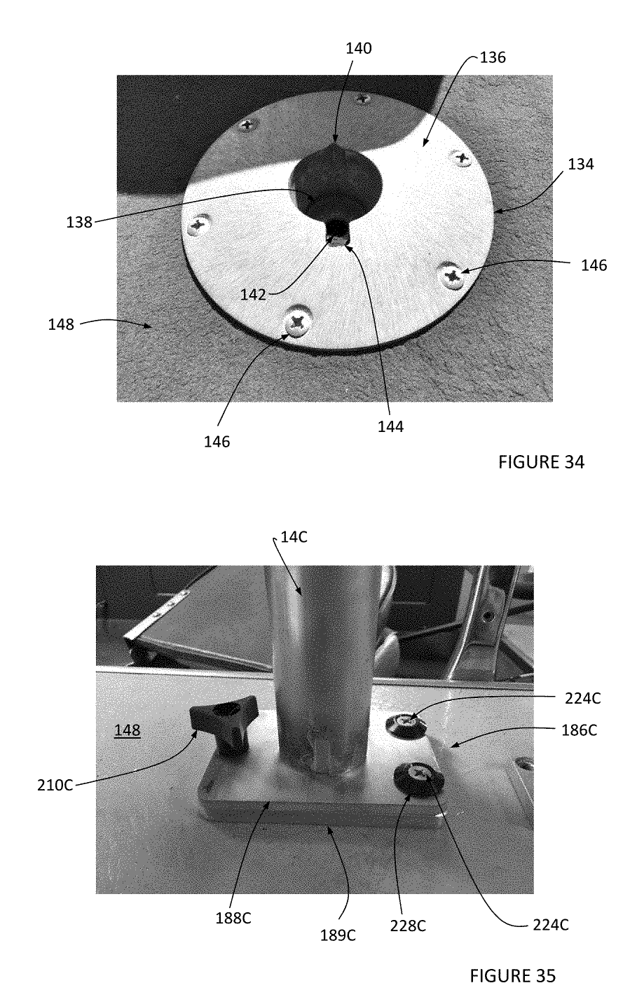

In one embodiment, FIGS. 1-6 depict an embodiment of a fishing rod holding device 10 comprising a low strut 14 releasably fixable to an anchor 134 at an inferior end. The low strut 14 in this embodiment is in the form of an elongate tube and comprises a transition interface 12 fixed to an inferior end of low strut 14 for releasable coupling with an anchor 134 (FIG. 34). A pivot strut 16 is pivotably coupled to the low strut 14.

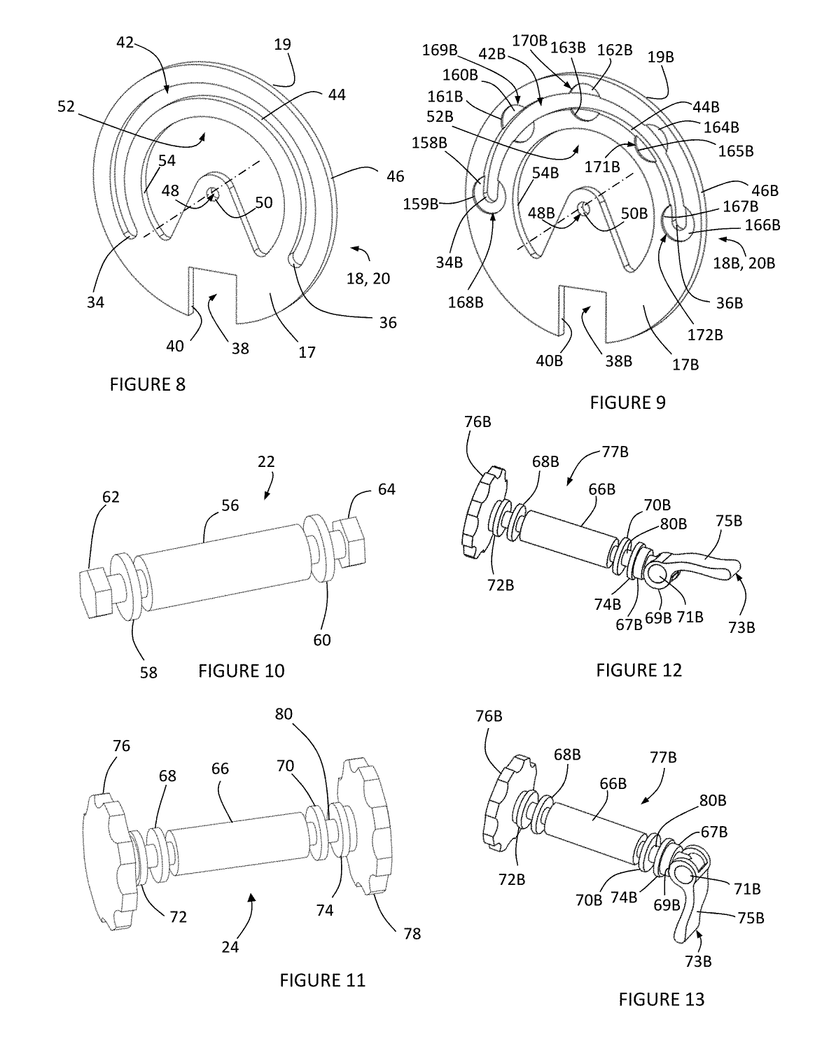

In this embodiment, a first range plate 18 is fixed to low strut 14 at strut surface 15. First range plate 18 is spaced from a second range plate 20 with each fixed to low strut 14 by welds although fasteners are used in other embodiments. A first range plate 18 and a second range plate 20 are generally flat with a generally circular profile defined by perimeter face 46 (FIG. 8). One skilled in the art will recognize profiles besides circular may be used. Each range plate comprises an arcing clamp channel 42 defined by a channel face 44 inset from a perimeter face 46 and extending between an outer range face 17 and an inner range face 19. Arcing clamp channel 42 extending between an outer range face 17 and inner range face 19 terminates in a first stop surface 34 and a second stop surface 36. An alignment notch 38 extends inward from perimeter face 46 of a range plate between a first stop surface 34 and second stop surface 36 for seating of a portion of a low strut 14 therein. Alignment notch 38 is defined by a notch face 40. Here, alignment notch 38 is generally rectangular in profile. Each of first range plate 18 and second range plate 20 comprises a generally centralized pivot aperture 48 defined by a pivot face 50 extending between outer range face 17 and an inner range face 19 for housing a pivot bolt 62.

In this embodiment, a weight aperture 52 defined by weight face 54 (FIG. 8) is positioned medial to clamp channel 42 and extends between outer range face 17 and inner range face 19 for weight reduction however the weight aperture may be absent in some embodiments. One or more of first range plate 18 and second range plate 20 are fixed at alignment notch 38 to strut surface 15 at a superior end of low strut 14 by weld 154.

As illustrated in FIG. 2, a pivot strut 16 comprises a pivot hole 23 extending along Axis F at an inferior end for housing a pivot assembly 22. A pivot hole 23 on pivot strut 16 is aligned with pivot aperture 48 on a range plate for controlled pivoting motion therebetween using a pivot assembly 22.

Pivot strut 16 comprises a clamp hole 21 along Axis E spaced from an inferior end for housing a clamp assembly 24 therein. Clamp hole 21 extends perpendicular through pivot strut 16 and is aligned with a clamp channel 42 on a range plate for pivotal clamping therebetween using a clamp assembly 24.

Pivot assembly 22 (FIG. 10) comprises a pivot spacer 56, a pivot bolt 62, a pivot nut 64, a first pivot washer 58, and a second pivot washer 60. In some embodiments, a bushing, such as a bronze bushing may be utilized to reduce wear between pivot bolt 62 and pivot strut 16.

One embodiment of a clamp assembly 24 (FIG. 11) comprises; a lock spacer 66, a clamp shaft 80, a first inner clamp washer 68, a second inner clamp washer 70, a first outer clamp washer 72, and a second outer clamp washer 74. In this embodiment, first clamp knob 76 is fixed to clamp shaft 80, whereas second clamp knob 78 threadably engages clamp shaft 80. In other embodiments, first clamp knob 76 and second clamp knob 78 both threadably engage clamp shaft 80. Advancing either or both first clamp knob 76 and second clamp knob 78 causes a frictional compression that clamps the pivot strut 16 in a desired position.

Holder assembly 25 comprises an upper rod holder 26 and a lower rod holder 28 and one or more of a first holder stabilizer 30 and a second holder stabilizer 32 extending between the upper rod holder 26 and lower rod holder 28. A portion of holder assembly 25 is fixed to a distal end portion of pivot strut 16 using one or more of welds and fasteners.

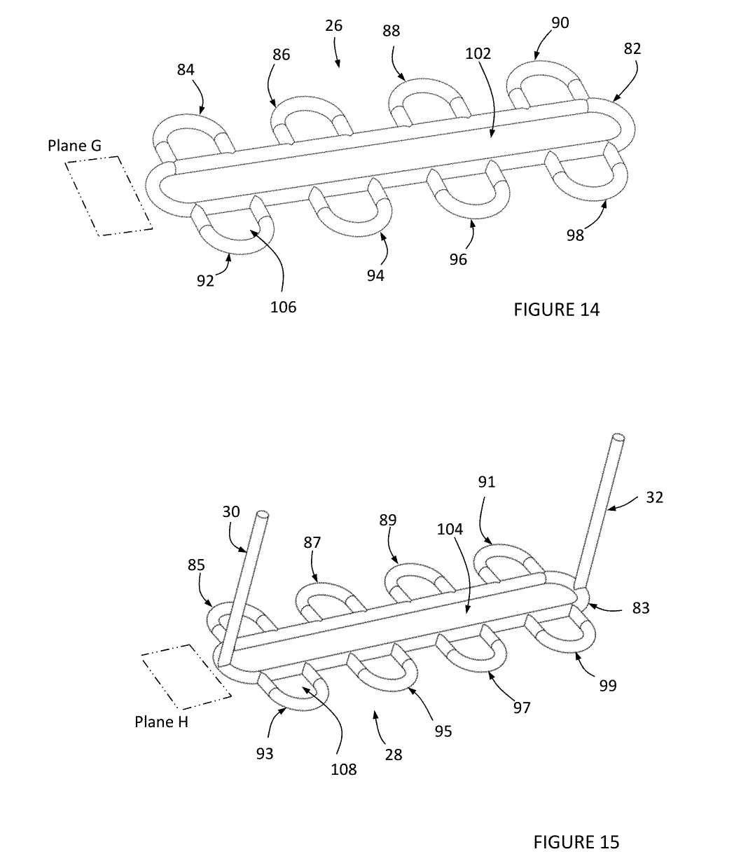

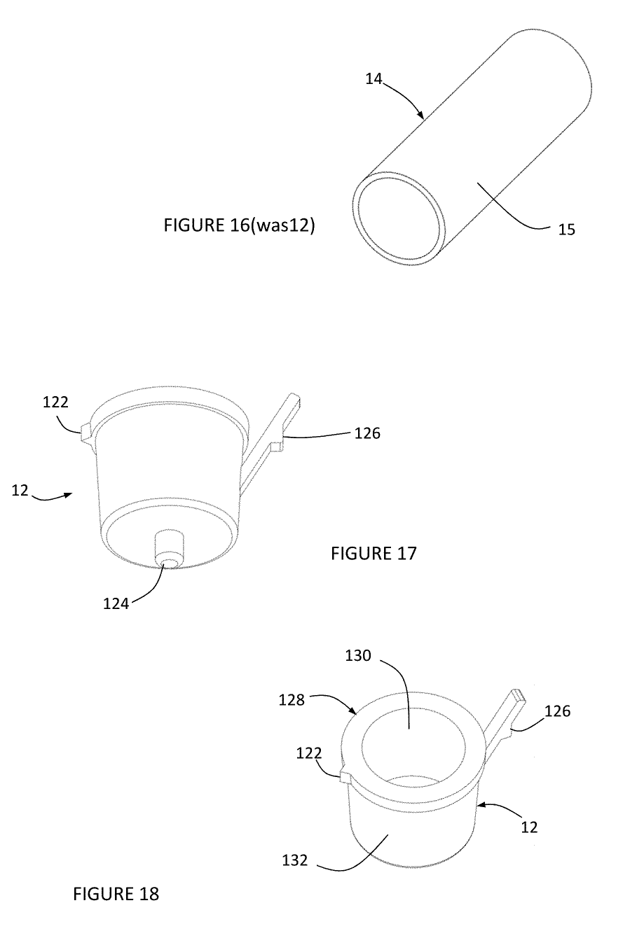

As illustrated in FIG. 14-15, upper rod holder 26 comprises an upper rod collar 82 which in this embodiment is generally oval having a generally oval first central aperture 102. Lower rod collar 83 is generally oval and has a generally oval second central aperture 104. One or more of first central aperture 102 and second central aperture 104 are sized to house a pivot strut 16 therein. Spaced radially from the upper rod collar 82 and said lower rod collar 83 are a plurality of cages illustrated as cages 84-99. Cages 84, 86, 88, 90, 92, 94, 96, 98 extend from upper rod collar 82 and generally reside in a common plane G with upper rod collar 82. Cages 85, 87, 89, 91, 93, 95, 97, 99 extend from lower rod collar 83 and generally reside in a common plane H with lower rod collar 83.

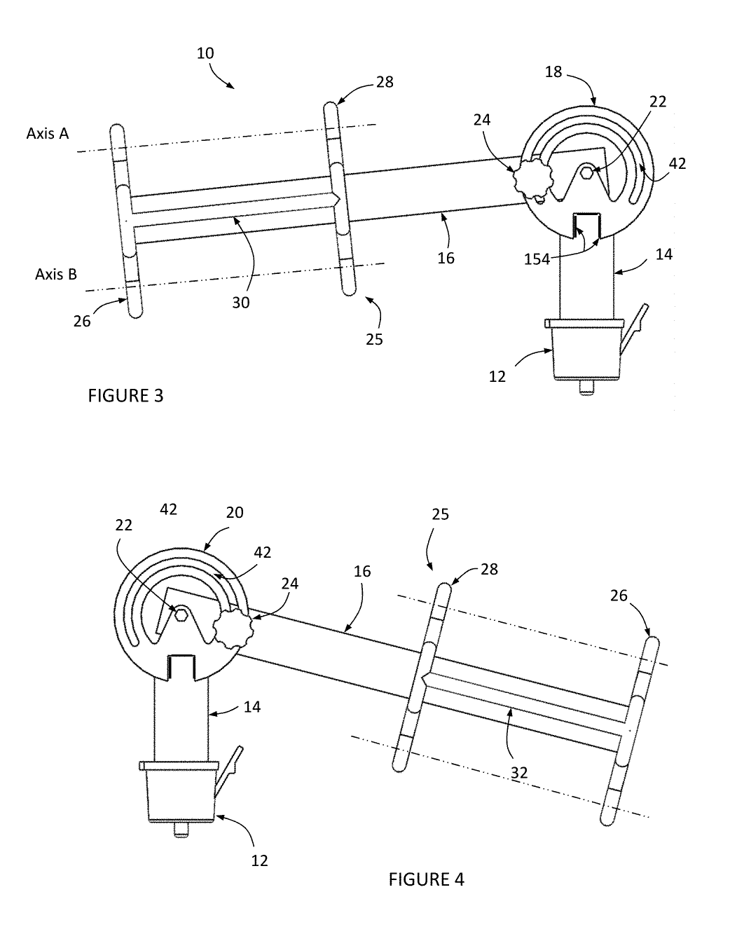

Upper cages 84-98 (even) define upper rod tunnels for containing a portion of a rod 150 therein. Lower cages 85-99 (odd) define lower rod tunnels for containing a portion of a rod 150 therein. In this embodiment, individual upper cages are generally aligned with individual lower cages as illustrated in FIG. 6 such that a rod 150 can be captured therein. This alignment between cages is also illustrated in FIG. 3 as Axis A and Axis B show alignment between rod tunnels of cages of upper rod holder 26 and lower rod holder 28. In some embodiments, the reel of a fishing rod is larger than the size of a corresponding upper rod tunnel (i.e. first upper rod tunnel 106) and therefore serves as a reel stop to keep the rod and reel positioned within holder assembly 25.

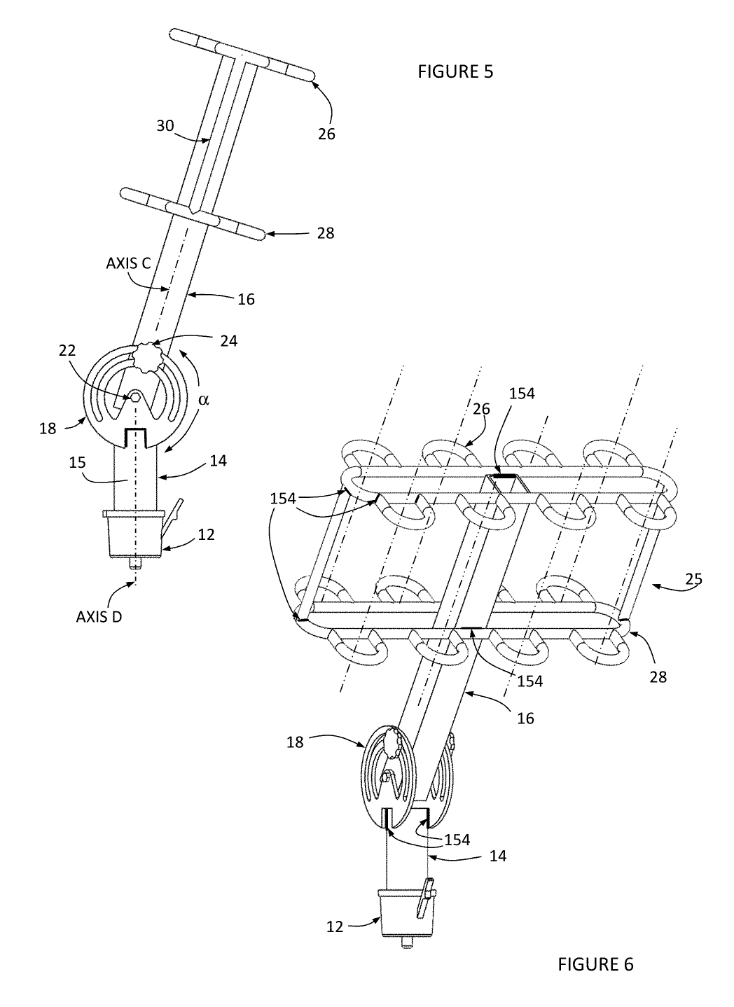

In this embodiment, holder assembly 25 is fixed to a distal end of pivot strut 16 using welds 154 (FIG. 6). Pivot strut 16 is pivotable through a range of motion thereby positioning rods 150 held within a holder assembly 25 in a plurality of angular positions. For example, FIG. 1 illustrates a generally upright orientation wherein a rod stored in holder assembly 25 would be held in a similar orientation. This generally upright orientation is useful while fishing. However, FIG. 3 illustrates a holder assembly 25 orientation that would be tilted toward one end of a boat such as the stern, whereas FIG. 4 illustrates a holder assembly 25 orientation that would be tilted toward an opposed end of a boat such as the bow. FIG. 5 illustrates a holder assembly positioned at a discreet position within a range thereby providing an adjustable angular relationship between Axis C of pivot strut 16 and Axis D of low strut 14.

Clamp shaft 80 of clamp assembly 24 travels within a clamp channel 42 of first range plate 18 and second range plate 20 wherein said clamp assembly 24 may be locked at any position within the clamp channel 42. In this embodiment, a pivot range of a pivot strut 16 is limited by interference between a portion of a clamp assembly 24 and one or more of a first stop surface 34 and a second stop surface 36 at terminal ends of a range plate clamp channel 42.

In this embodiment, clamp assembly 24 is locked by advancing one or more of a first clamp knob 76 and a second clamp knob 78 causing a frictional locking between the clamp assembly 24 and a corresponding range plate in a locked configuration. Clamp assembly 24 is unlocked by reversing advancement of one or more of a first clamp knob 76 and a second clamp knob 78 causing a reduction of frictional locking between clamp assembly 24 and a corresponding range plate in an unlocked configuration.

Adjusting the angulation of a holder assembly 25 comprises the steps of placing a fishing rod holding device 10 in an unlocked configuration and adjusting a corresponding pivot strut 16 to a new predetermined position, then changing the corresponding clamp assembly 24 to a locked configuration.

In one embodiment, low strut 14 is removably housed in a generally vertical orientation within a bore of an anchor device. A variety of coupling mechanisms utilized in the prior art that provide stationary holding of a low strut may be utilized. It is preferable that the coupling mechanism includes the ability to release and remove a rod holding device for storage purposes although the low strut may be permanently fixed in a predetermined position. FIG. 17-18 illustrate one style of coupling mechanism available from the prior art for utilization with the anchor 134 of FIG. 34. In this embodiment, fishing rod holding device 10 comprises a transition interface 12 at a proximal end of a low strut 14 as illustrated in FIG. 6. Here, transition interface 12 is in the form of an interface cup. Interface cup 128 comprises an inner cup face 130 having a size and profile for seating a proximal end of a low strut 14 therein. Interface cup 128 also comprises an outer cup face 132 having a size and profile suited for seating within anchor 134 (FIG. 34). Interface cup 128 comprises a high position boss 122 for seating within a complementing high notch 140 of anchor 134. Interface cup 128 also comprises a low position boss 124 for seating within a complementing low socket 142 of anchor 134, and a lever lock 126 for releasably securing an interface cup 128 within anchor 134. Further to this embodiment, anchor 134 comprises a base 136 portion comprising a cup holder 138 portion sized and shaped for seating a complementary transition interface 12 therein. Anchor 134 has a broad base 136 having screw holes at its periphery for securing to a base panel 148 (such as a floor or rail of a boat) using one or more base screws 146. In this embodiment, base panel 148 is the floor of a boat but may also be in the form of a horizontal surface elevated from the floor of a boat. When a fishing rod holding device 10 is removed from an anchor 134, the anchor 134 may be used to support a removable seat.

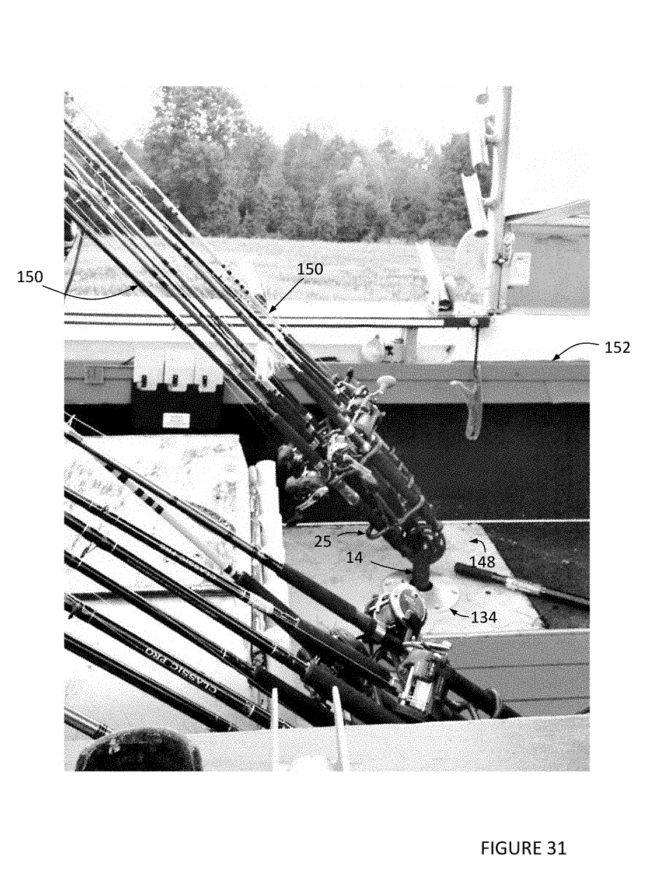

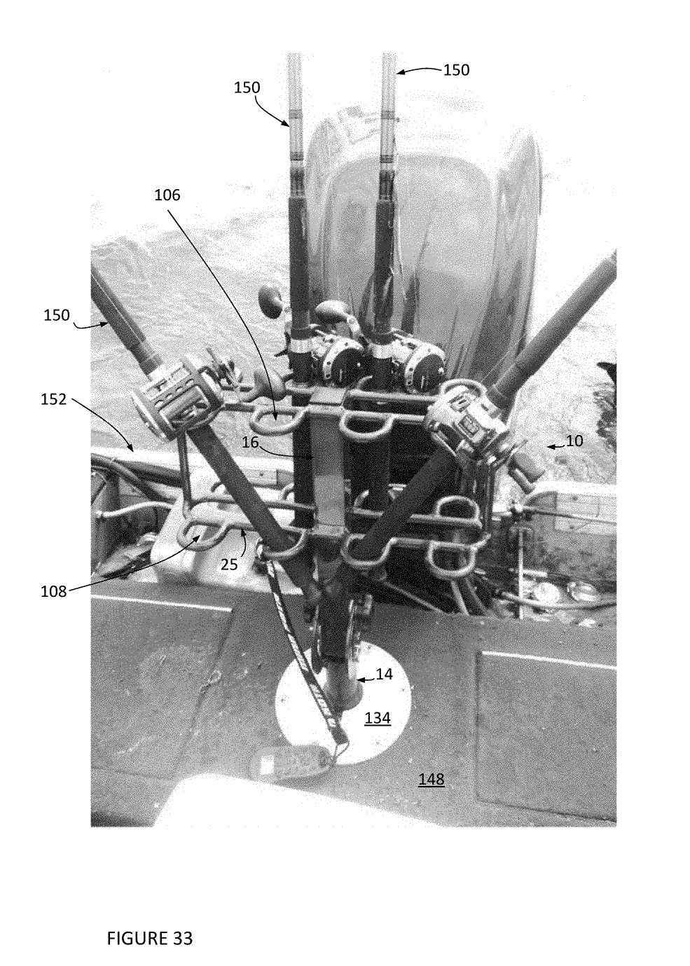

Fishing rod holding device 10 in preferred embodiments holds a plurality of fishing poles 150 as illustrated in FIGS. 31-33. In addition, in some embodiments, fishing rod holding device 10 may be removed from an anchor for storage as illustrated in FIG. 33 by depressing lever lock and lifting then relocating fishing rod holding device 10 with any fishing rods 150 therein.

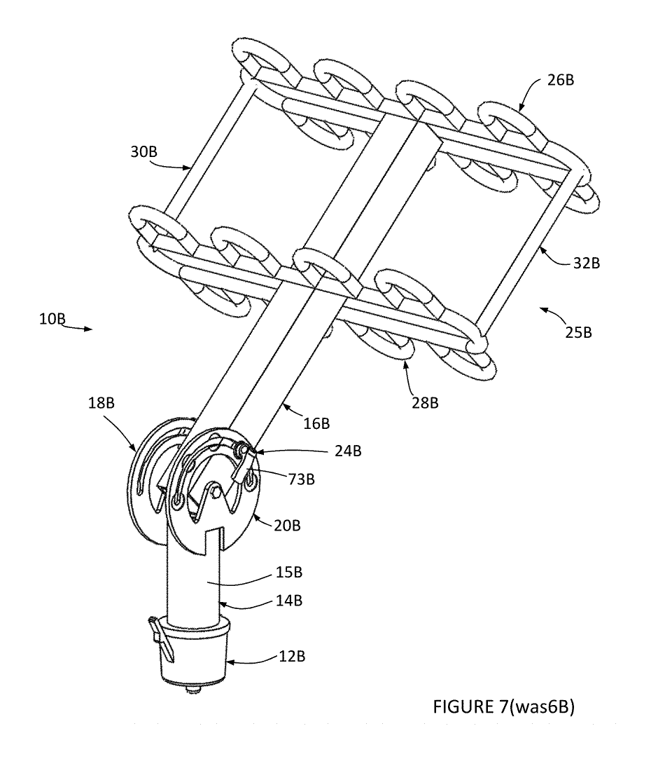

FIG. 7 illustrates another embodiment of a fishing rod holding device 10B comprising one or more range plates (first range plate 18B and second range plate 20B) having a plurality of lock pockets for locking of a holder assembly 25B in a variety of predetermined angular positions with respect to a low strut 14B. Here, a clamp assembly 24B is in the form of a cammed quick release rod and skewer 77B (FIG. 12, 13) which comprises a cam pad 67B on which a camlobe 69B from a cam lever 73B articulates. A cam shaft 71B is positioned generally perpendicular to a clamp shaft 80B of the cammed quick release rod and skewer 77B. The clamp assembly 24B is locked by pivoting cam lever 73B wherein camlobe 69B creates compression against cam pad 67B causing a frictional locking between the clamp assembly and corresponding range plate 18B, 20B in a locked configuration (FIG. 13). A clamp assembly is unlocked by reversing pivoting of a cam lever 73B causing a frictional loosening between the clamp assembly and corresponding range plate 18B, 20B in an unlocked configuration (FIG. 12). A cam handle 75B is disposed on cam lever 73B for gripping by a user. In some embodiments, range plate pairs are used in one of the following configurations; both range plates comprise lock pockets, only one range plate comprises lock pockets, and neither range plate comprises lock pockets.

In the embodiment of FIG. 7, one or more of a first range plate 18B and a second range plate 20B comprises a plurality of recess surfaces (first through fifth recess surfaces 158B, 160B, 162B, 164B, 166B) inset in an outer range face 17B. The recess surfaces are radially centered and spaced about a clamp channel 42B. A plurality of lock faces (first through fifth lock faces 159B, 161B, 163B, 165B, 167B) extend between the respective recess surfaces and corresponding outer range face 17B. A plurality of lock pockets (first through fifth lock pockets 168B, 169B, 170B, 171B, 172B) are formed in an outer range face 17B of a range plate and are defined by a corresponding recess surface and a lock face.

Each lock pocket is sized and shaped to seat a first or second outer clamp washer 72B, 74B (in alternative embodiments, cammed clamp assemblies may be used with lock pockets removed). In a locked configuration, a corresponding outer clamp washer abuts a lock face to prevent pivoting movement of a range plate from a predesignated position. In an unlocked configuration, an outer clamp washer is able to move past a lock face on the range plate to provide for pivoting adjustment of a holder assembly to a predesignated position.

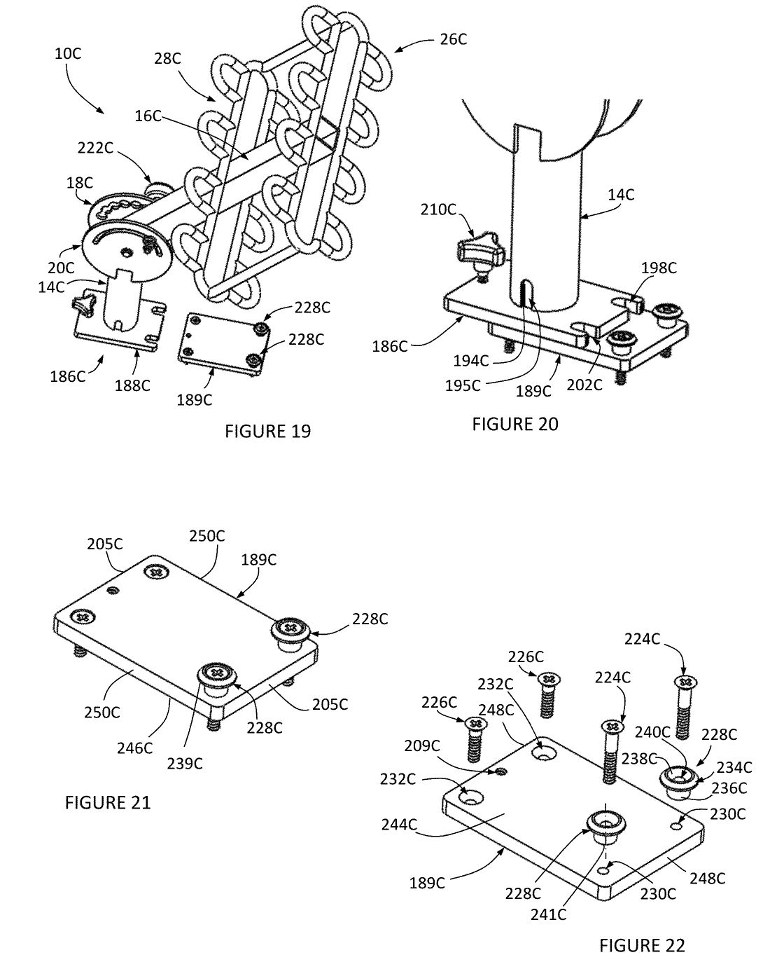

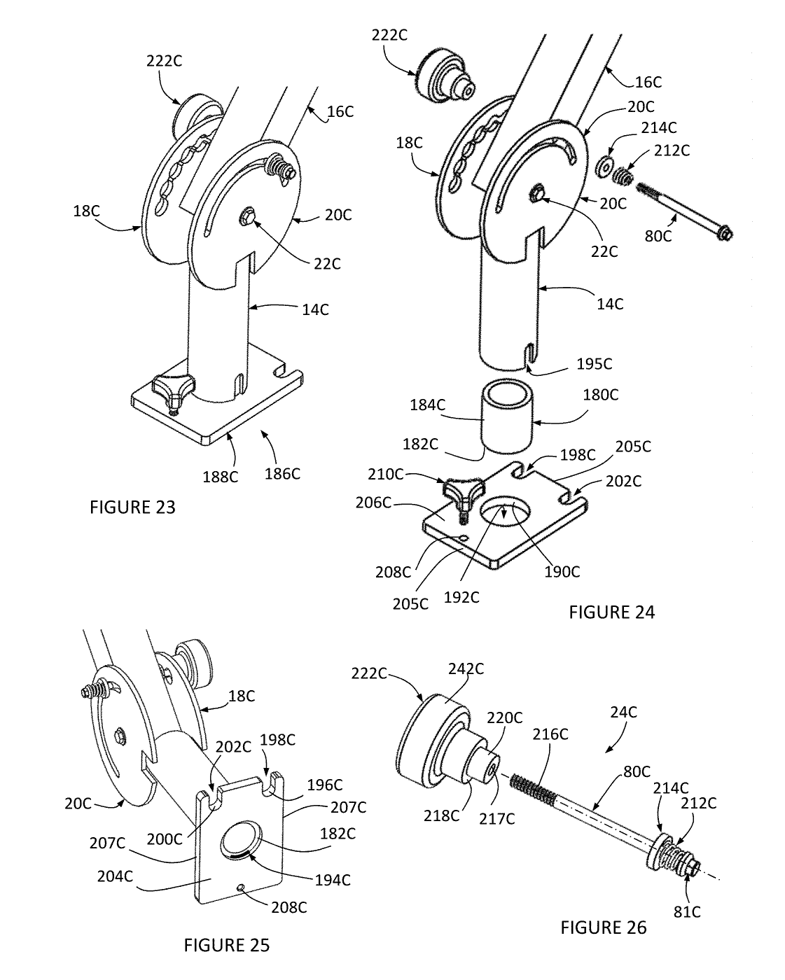

FIGS. 19-30 illustrate yet another embodiment of a rod holding device 10C. In this embodiment, a clamp assembly 24C is in the form of a clamp shaft 80C that is biased in one direction. The clamp assembly 24C comprises an engagement knob 222C mounted on one end of clamp shaft 80C by for example threads, pins, clips, compression, or other means known in the art. An engagement spring 212C is seated over clamp shaft 80C adjacent clamp head 81C for biasing the clamp shaft 80C in one direction. A washer 214C may be placed against the spring base. An engagement knob 222C comprises a radially positioned engagement face 220C sized to engage a lock pocket (i.e. ninth lock pocket 176C) on first range plate 18C.

In this embodiment, engagement knob 222C comprises at least one grasp face 242C for grasping by a user's hand to distract clamp assembly. In addition, engagement knob 222C comprises a stop face 218C for abutting with outer range face 17C of range plate 18C. First engagement threads 216C on clamp shaft 80C engage with second engagement threads 217C of engagement knob 222C. Distracting engagement knob 222C against engagement spring 212C force unlocks engagement face 220C from a lock pocket thereby providing consequent angle adjustment of pivot strut 16C relative to low strut 14C. Once a new angle adjustment is chosen, engagement knob 222C is released causing consequent engagement of engagement face 220C in an alternative lock pocket. During this angular adjustment, clamp shaft 80C is pivotable through clamp channel 42C for adjustment of a pivot strut angle α (between Axis C and D).

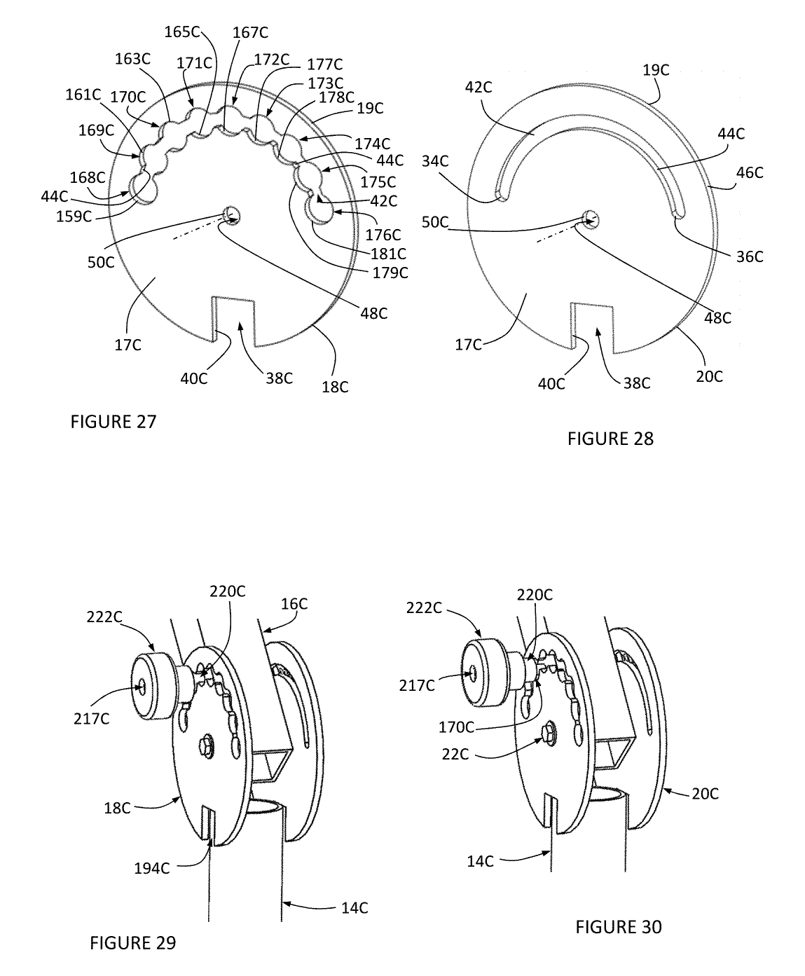

As noted in FIG. 27, first range plate 18C comprises a series of first through ninth lock faces (i.e. respectively 159C, 161C, 163C, 165C, 167C, 177C, 178C, 179C, 181C) forming first through ninth lock pockets (i.e. respectively 168C, 169C, 170C, 171C, 172C, 173C, 174C, 175C, 176C) along the length of clamp channel 42C which is defined by channel face 44C. As illustrated, the lock faces are sized and shaped to seat an engagement face 220C of engagement knob 222C therein. Force from engagement spring 212C causes stop face 218C to remain adjacent to outer range face 17C until disengaged by the user. First range plate 18C and second range plate 20C (absent of lock pockets along a clamp channel) are positionally aligned as illustrated in FIGS. 29 and 30.

In this embodiment (FIG. 19-25), low strut 14C terminates in a releasable foot 186C which is configured for releasable fixation to anchor plate 189C. The releasable foot 186C comprises a foot plate 188C fixed to low strut 14C. In some embodiments, one or more welds join the low strut 14C to the foot plate 188C. In other embodiments, a base strut 180C reinforces the junction between low strut 14C and foot plate 188C. As illustrated, the base strut 180C is in the form of a tube and resides within low strut 14C.

In this embodiment, low strut 14C comprises at least one weld notch 195C at an inferior end that joins low strut 14C with base strut 180C using a weld 194C. Base strut 180C, having a base face 182C at an inferior end and radial face 184C, is seated in ring aperture 192C. Ring aperture 192C is defined by ring wall 190C and extends through foot plate 188C between a foot bottom 204C and foot top 206C. A weld 194C secures base face 182C to ring wall 190C as illustrated in FIG. 25. Foot plate 188C comprises an opposing first slot 198C (defined by first slot face 196C) and second slot 202C (defined by second slot face 200C) extending between a foot bottom 204C and foot top 206C from a foot end face 205C of foot plate 188C. Foot plate 188C also comprises opposing foot side faces 207C.

As illustrated, anchor plate 189C is configured for releasable locking with a foot plate 188C. An upper lock aperture 208C for housing a lock bolt 210C extends from a foot top 206C to a foot bottom 204C of foot plate 188C. Anchor plate 189C comprises opposed anchor end surfaces 248C and opposed anchor side surfaces 250C. In addition, anchor plate 189C comprises opposed first plate holes 230C and opposed second plate holes 232C extending between an anchor top surface 244C and anchor bottom surface 246C at opposed ends of the anchor plate 189C. In this embodiment, at least one of the first plate holes 230C and second plate holes 232C are counter sunk or counter bored for seating of the head of a plate fastener therein.

Further to this embodiment, lock collar 228C is configured for seating within one or more of first slot 198C and second slot 202C of foot plate 188C to provide releasable fixation at one end of the foot plate 188C. The lock collar 228C comprises a toe wall 236C sized to fit within one or more of a first slot 198C and second slot 202C of foot plate 188C. A bottom collar face 241C seat against an anchor top surface 244C. A radially enlarged rim 234C is spaced from the bottom collar face 241C for seating of foot plate 188C therebetween. The radially enlarged rim 234C comprises a rim face 239C for engaging the foot top 206C of a foot plate 188C when the lock collar 228C is seated within a first slot 198C or second slot 202C. In addition, lock collar 228C comprises a collar aperture 240C extending through lock collar 228C along a central axis. A countersunk or counter bored head recess 238C provides seating the head of a plate fastener therein.

As illustrated in FIG. 22, anchor plate 189C comprises a lower lock aperture 209C extending between anchor top surface 244C and anchor bottom surface 246C of anchor plate 189C. In this embodiment, lower lock aperture 209C is threaded to complement lock bolt 210C. Upper lock aperture 208C and lower lock aperture 209C are aligned when releasable foot 186C is mated with the anchor plate 189C. First foot plate fastener 224C extends through collar aperture 240C of a lock collar 228C and through a first plate hole 230C of anchor plate 189C then seated in a base panel of a boat. In this embodiment, second foot plate fastener 226C extends through a second plate hole 232C of an anchor plate 189C and is then seated in a base panel 148C of a boat. The head of second foot plate fastener 226C is seated in a counter sunk or counter bored portion of a second plate hole 232C.

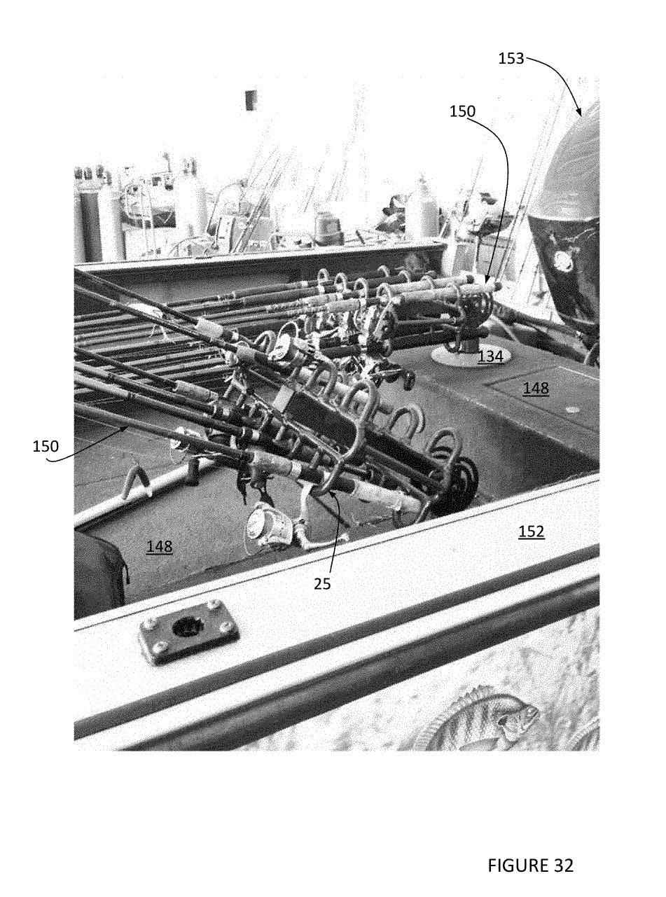

FIG. 31 illustrates one embodiment of a fishing rod holding device with one or more fishing rods 150 seated within an upper rod tunnel and lower rod tunnel of a holder assembly 25. Here, holder assembly 25 is shown angled towards the bow of the boat. FIG. 32 illustrates another embodiment of a pair of fishing rod holding devices 10 with one secured to an anchor 134 fixed to a base panel 148 on the floor of a boat and the other fixed to an anchor 134 fixed to a base panel 148 elevated from the floor of a boat 152 in front of boat motor 153. The low angled position not only makes transport of rods tidy and convenient, it also angles fishing rods 150 such that they clear overhead obstacles such as garage door headers. In addition, the feature to lower fishing rods 150 adds convenience of neatly storing fishing rods in a boat while not obstructing the use of a boat cover.

FIG. 33 illustrates yet another embodiment of a fishing rod holding device 10 seated in an anchor 134 fixed to an elevated base panel 148 of a boat 152. In this embodiment, some of the fishing rods 150 are held in aligned upper and lower rod tunnels 106, 108 of corresponding cages whereas other fishing rods are angled outwards by insertion into rod tunnels that are misaligned.

FIG. 34 illustrates one style of anchor 134 known in the prior art secured to a base panel 148 of a boat 152 by the use of base screws 146. A cup holder 138 is sized and shaped to receive a transition interface 12 of the variety illustrated in FIGS. 17-18 and utilized in the rod holding device of FIG. 7 and other embodiments. As illustrated in FIG. 33, cup holder 138 seats transition interface 12 therein thus holding low strut 14 generally vertical in an operational configuration. Anchor 134 comprises high notch 140, low socket 142, and lever notch 144 to complement respective features high position boss 122, low position boss 124, and lever lock 126 of transition interface 12 for seating therein.

FIG. 35 illustrates one embodiment of a releasable foot 186C locked into an anchor plate 189C that is fixed to a base panel 148 of a boat. Each lock collar 228C is seated in a respective first slot 198C and a second slot 202C of foot plate 188C. Lock bolt 210C extends through foot plate 188C and securing into anchor plate 189C.

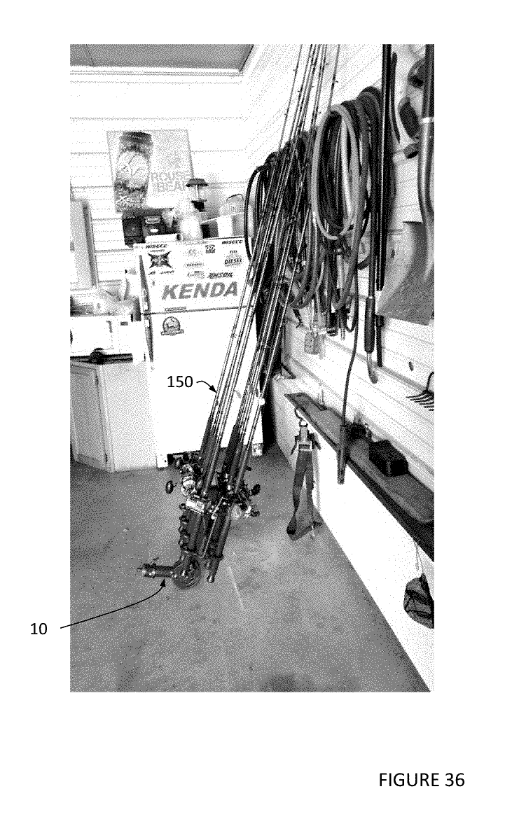

FIG. 36 illustrates an embodiment of a fishing rod holding device 10 released from its anchor 134 in a storage configuration and here resting against the wall of a garage.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A rod holding device comprising:
an elongate low strut;
an elongate pivot strut;
a first range plate;
a second range plate;
said first range plate spaced from said second range plate;
said first range plate fixed to a superior end of said low strut;
said second range plate fixed to a superior end of said low strut;
said low strut positioned between said first range plate and said second range plate;
a pivot aperture;
said pivot aperture extending through said first range plate and said second range plate along an axis;
a pivot hole;
said pivot hole extending through opposing sides of said pivot strut at an inferior end;
said pivot hole on said pivot strut aligned with said pivot apertures of said first range plate and said second range plate;
a clamp hole;
said clamp hole extending through said pivot strut spaced superiorly and generally parallel to said pivot aperture;
said first range plate and said second range plate having an inner range face and outer range face;
an arced clamp channel extending between said inner range face and said outer range face of said first range plate and said second range plate;
wherein said arced clamped channel in said first range plate is aligned with said arced clamped channel of said second range plate;
said pivot strut positioned between said first range plate and said second range plate;
a pivot assembly;
said pivot assembly seated in said pivot aperture of said first range plate and said second range plate and said pivot hole of said pivot strut for controlled pivoting of said pivot strut with respect to said low strut;
a clamp assembly;
said clamp assembly disposed in said clamp channel of said first range plate and said second range plate and said clamp hole of said pivot strut;
a holder assembly for holding rods therein;
said holder assembly comprising an upper rod holder spaced from a lower rod holder;
wherein at least one of said upper rod holder and said lower rod holder is fixed to said pivot strut; and
wherein an inferior end of said low strut stands generally vertical in an operational configuration.

2. The rod holding device according to claim 1 wherein;
said clamp assembly further comprises a first clamp knob, a first outer clamp washer, and a second outer clamp washer;
wherein advancing said first clamp knob advances said first outer clamp washer towards said second outer clamp washer resulting in consequent frictional locking between said clamp assembly and said first range plate and said second range plate.

3. The rod holding device according to claim 1 wherein:
said clamp assembly further comprises a clamp shaft, a cam lever, a first outer clamp washer, and a second outer clamp washer; and
said cam lever articulates with one end of said clamp shaft; and
wherein advancing said cam lever results in consequent locking between said clamp assembly and said first range plate and said second range plate.

4. The rod holding device accord to claim 1 further comprising:
an engagement spring;
an engagement knob;
wherein said engagement spring biases said engagement knob toward said first range plate.

5. The rod holding device of claim 4 further comprising:
an engagement face;
a stop face;
said engagement face encircling a portion of said engagement knob about a central engagement knob axis;
wherein the diameter of said engagement face is larger than said clamp channel;
a plurality of lock pockets;
said plurality of lock pockets spaced along said clamp channel;
said plurality of lock pockets sized for seating said engagement face therein and extending through said first range plate;
wherein said engagement face is housed within one of said lock pockets therein fixing said angular position between said pivot strut and said lower strut.

6. The rod holding device of claim 5 wherein the diameter of said clamp shaft is sized to pivotably move through said clamp channel between said plurality of lock pockets.

7. The rod holding device according to claim 1 wherein:
said upper rod holder and said lower rod holder further comprise a plurality of cages for holding rods therein; and
wherein each of two or more cages from said upper rod holder and each of two or more cages from said lower rod holder are aligned along an axis.

8. The rod holding device according to claim 7 wherein each of said upper rod holder and said lower rod holder have eight cages.

9. The rod holding device according to claim 1 further comprising:
said upper rod holding having an upper rod collar;
said lower rod holder having a lower rod collar;
wherein each said upper rod collar and each said lower rod collar encircle said pivot strut and wherein said plurality of cages extend from said upper rod collar and said lower rod collar.

10. The rod holding device according to claim 9 further comprising:
a first holder stabilizer;
a second holder stabilizer;
wherein said first holder stabilizer and said second holder stabilizer extend between said upper rod holder and said lower rod holder.

11. The rod holding device according to claim 1 further comprising:
a releasable foot;
said releasable foot comprising a foot plate and an anchor plate; and
wherein said foot plate is releasably fixed to said anchor plate.

12. The rod holding device according to claim 11 further comprising:
at least one first plate fastener;
said anchor plate having an anchor top surface and an anchor bottom surface;
a first plate hole extending between said anchor top surface and said anchor bottom surface;
at least one second plate fastener;
a second plate hole extending between said anchor top surface and said anchor bottom surface;
wherein said at least one first plate fastener extends through a said first plate hole for fixing one end of said anchor plate to a base panel; and
wherein said at least one second plate fastener extends through a said second plate hole for fixing an opposing end of said anchor plate to a base panel.

13. The rod holding device according to claim 12 further comprising:
a lock collar;
said lock collar comprising an enlarged rim;
said enlarged rim spaced from said anchor plate top surface;
wherein a portion of said foot plate is captured under said enlarged rim of said lock collar when said foot plate is locked to said anchor plate in an operational configuration.

14. The rod holding device according to claim 13 further comprising;
a first slot;
a foot end face at one end of said foot plate;
said first slot extending through said foot plate at a foot end face of said foot plate;
wherein said lock collar is seated in said first slot when said foot plate is locked to said anchor plate.

15. The rod holding device according to claim 12 further comprising:
a lock bolt;
an upper lock aperture extending through said foot plate;
a lower lock aperture extending through said anchor plate;
wherein a portion of said lock bolt extends through said upper lock aperture and said lower lock aperture when said foot plate is locked to said anchor plate.

16. The rod holding device of claim 11 wherein said releasable foot further comprises:
a foot plate;
a ring aperture extending through said foot plate;
a base strut extending orthogonally from said foot plate;
one end of said base strut fixed within said foot plate;
said lower strut comprising a weld notch at an inferior end of said lower strut;
wherein said lower strut is fixed to said based strut.

17. The rod holding device of claim 1 further comprising:
a releasable foot;
said releasable foot comprising an anchor plate;
said releasable foot at an inferior end of said lower strut;
wherein said anchor plate comprises a first slot;
wherein said first slot is engaged with said locking collar;
and wherein said lock bolt is threadably engaged with said anchor plate when said rod holding device is fixed to said anchor plate in an operational configuration.

18. The rod holding device of claim 1 further comprising:
a transition interface;
a high position boss;
a low position boss;
wherein said transition interface comprises an interface cup configured to receive and fixate an inferior end of said lower strut therein for releasable fixation to an complementary anchor fixed to a base panel of a boat.

19. The rod holding device of claim 1 wherein said clamp channel has an arc range of about 160 degrees.

20. A rod holding device comprising:
an elongate low strut;
an elongate pivot strut;
a first range plate;
a second range plate;
said first range plate spaced from said second range plate;
said first range plate fixed to a superior end of said low strut;
said second range plate fixed to a superior end of said low strut;
said low strut positioned between said first range plate and said second range plate;
a pivot aperture;
said pivot aperture extending through said first range plate and said second range plate along an axis;
a pivot hole;
said pivot hole extending through opposing sides of said pivot strut at an inferior end;
said pivot hole on said pivot strut aligned with said pivot apertures of said first range plate and said second range plate;
said pivot strut positioned between said first range plate and said second range plate;
a pivot assembly;
said pivot assembly seated in said pivot aperture of said first range plate and said second range plate and said pivot hole of said pivot strut for controlled pivoting of said pivot strut with respect to said low strut;
a clamp assembly for locking angulation between said low strut and said pivot strut;
a holder assembly for holding rods therein;
said holder assembly comprising an upper rod holder spaced from a lower rod holder;
wherein at least one of said upper rod holder and said lower rod holder is fixed to said pivot strut; and
wherein an inferior end of said low strut stands generally vertical in an operational configuration.
